(19) United States
(12) Patent Application Publication
(10) Pub. No.: US 2009/0319922 A1
(43) Pub. Date: Dec. 24, 2009

(54) Non-Bypassable Disclosures in Electronic Transactions

(75) Inventors: Vinay Kumar Nooka, Charlotte, NC (US); Mark T. Tweddale, Charlotte, NC (US); Alexandra Fridman, Ashland, MA (US); Rebecca Smoot, Charlotte, NC (US); Robert J. Flemma, JR., Charlotte, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 12/142,345

(22) Filed: Jun. 19, 2008

(51) Int. Cl. G06F 3/048; G06F 15/16

(52) U.S. Cl. 715/760; 715/808; 715/804; 715/805; 709/203

(57) ABSTRACT

Methods, software, and systems for ensuring that one or more pieces of information are presented as a “non-bypassable” manner and can be viewed as intended during an electronic transaction. For instance, where a required disclosure is provided in a pop-up window, it may be provided that the party receiving the disclosure may not complete the application until it is shown that the pop-up window content has fully loaded and thus available to the consumer to review as intended. The pop-up window content may itself include an instruction for determining when the content has been fully loaded. Upon the content being fully loaded, the pop-up window may send a call to the parent window indicating that the content has been fully loaded. In response to the call, the parent window may allow the application process to continue or complete. According to further aspects, it may be determined whether the consumer's computer Internet browser is enabled for use with the call language (for example, JAVASCRIPT).

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

In 2000, the United States Congress enacted the Electronic Signatures in Global and National Commerce Act, also known as the E-Sign Act. The main purpose of the E-Sign Act was to ensure that certain electronic communications and signatures obtained electronically are not denied legal effect solely because they were provided or obtained in electronic form—thereby according these communications and signatures parity with their paper equivalents. Electronic communications and signatures have become common as Internet-based transactions become the norm.

To obtain the protection afforded by the eSign Act, certain legal requirements must be met including a requirement that a consumer “reasonably demonstrate” that he/she can access and view information in the electronic form that will be used to provide disclosures and/or obtain an electronic signature or consent.

In addition, a number of state and federal laws and regulations require the delivery of certain disclosures and other information as part of a transaction and, when such materials are to be delivered electronically, that they be delivered in a way that the recipient cannot “bypass” or avoid. Both the “reasonable demonstration” test under the eSign Act and state and federal “non-bypassability” requirements may require the delivering party to establish that the other party received and had the ability to access and view the required information electronically and in the intended format.

While electronic signatures have been used for some time, and there are other ways to meet the “reasonable demonstration” test required by the eSign Act or to ensure that required information is presented in a “non-bypassable” way, it has not always been easy for many businesses to establish that they have met these requirements when, for example, the required information has been delivered through a hyperlink that contains the information or the information is presented automatically in pop-up form such as in a pop-up window during the application process. However, not all bank web sites require that the consumer cause the pop-up window to appear prior to completing the application. In other words, the consumer could simply bypass the consumer disclosure and proceed with the application process. Other bank web sites may not allow the consumer to bypass the consumer disclosure, however they are unable to guarantee that the disclosure is fully loaded/presented to the customer (e.g., the customer may close a pop-up window prior to the disclosure being presented in the window, or an error may occur preventing the disclosure from presenting to the customer).

### SUMMARY

Aspects of the present invention provide a way to ensure that a consumer who is filling out an electronic form at minimum has received and has an opportunity to review the consumer disclosure prior to completing the application, by making loading of the consumer disclosure onto the consumer's computer (and thus making it available for display) a non-bypassable part of the application process. For instance, where the consumer disclosure is provided in a pop-up window, it may be provided that the consumer may not complete the application until it is shown that the pop-up window content has fully loaded and thus available to the consumer to review in the intended format.

According to some aspects, the pop-up window content may itself include a computer-executable instruction for determining when the content has been fully loaded. Upon the content being fully loaded, the pop-up window may send a call, such as a JAVASCRIPT call, to the parent window indicating that the content has been fully loaded. In response to the call, the parent window may allow the application process to continue or complete.

According to further aspects, it may be determined whether the consumer's computer Internet browser is enabled for use with the call language (for example, JAVASCRIPT). When the customer clicks on a consumer disclosure link, the pop-up window is opened. Within the pop-up window, before loading any content, the consumer's browser is attempted to be redirected using a JAVASCRIPT function to the same pop-up window URL (or to a different URL containing the pop-up window), with an extra URL parameter that indicates whether JAVASCRIPT is enabled or not. When JAVASCRIPT is disabled at the consumer's computer, the redirection doesn't occur because the JAVASCRIPT redirect function will not operate and there will not be parameter in the URL indicating that JAVASCRIPT is enabled. Based on whether the parameter is present or not in the URL, it can be determined whether JAVASCRIPT is enabled at the consumer's computer.

By requiring display of the required information during the application process and by confirming that the required information has been successfully loaded by the consumer's computer, the delivering party is able to satisfy any “reasonable demonstration” or applicable non-bypassability requirements.

These and other aspects of the disclosure will be apparent upon consideration of the following detailed description.

### BRIEF DESCRIPTION OF THE DRAWINGS

A more complete understanding of the present disclosure and the potential advantages of various aspects described herein may be acquired by referring to the following description in consideration of the accompanying drawings, in which like reference numbers indicate like features, and wherein:

FIG. 1 is a functional block diagram of an illustrative computing environment that may be used to practice various aspects of the invention.

FIG. 2 is a flow chart of an illustrative method that may be performed by the computing environment of FIG. 1.

FIG. 3 is a flow chart of an illustrative set of steps that may be performed as part of the method of FIG. 2.

FIGS. 4 and 5 are illustrative web page screenshots.

### DETAILED DESCRIPTION

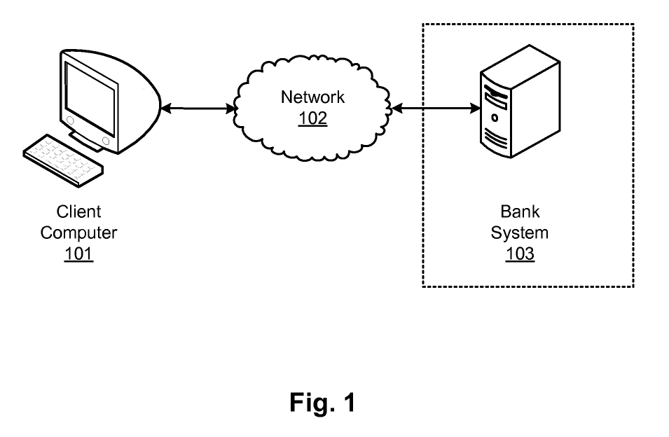

FIG. 1 is a functional block diagram of an illustrative computing environment that may be used to practice various aspects of the invention. In this particular computing environment, a client computer 103 is provided, which is communicatively coupled to a bank system 103 via a network 102.

Client computer 103 may be any type of computer, or combination of computers thereof, such as a desktop computer, a laptop computer, a handheld computer (e.g., a smart cellular phone and/or personal digital assistant), and/or a server. Client computer 103 may be configured with software so as to be able to communicate with bank system 103. For instance, where communications are via an Internet web site generated by bank system 103, client computer 103 may include web browser software, such as Microsoft EXPLORER web browser software or Netscape NAVIGATOR web browser software.

Network 102 may be any type of network or combination of networks, such as the Internet, a local area network (LAN), a wide area network (WAN), and/or a telephone network.

Bank system 103 may include any one or more types of computers. For instance, bank system 103 may include a collection of interconnected servers, such as a web server (for generating web pages viewable by client computer 101), a financial form server (for generating financial account consumer application forms), and a database server (for storing information about consumer application forms and/or about consumers themselves). Other configurations are possible.

Client computer 101 and any computers that are part of bank system 103 may include or otherwise have access to computer-readable media. The term “computer-readable medium” refers to any medium, or combination of plural media, that is capable of storing information in a form that can be readable by a computer. Examples of a computer-readable medium include magnetic storage media such as hard drives, magnetic tape, and magnetic floppy disks; optical storage media such as compact discs (CDs), and memory such as random access memory (RAM) and read-only memory (ROM). The computer-readable media to which client computer 101 and bank system 103 have access may store both computer-executable instructions (e.g., software and operating systems) as well as data, which together may cause client computer 101 and bank system 103 to perform any of the functions attributed to them as described herein.

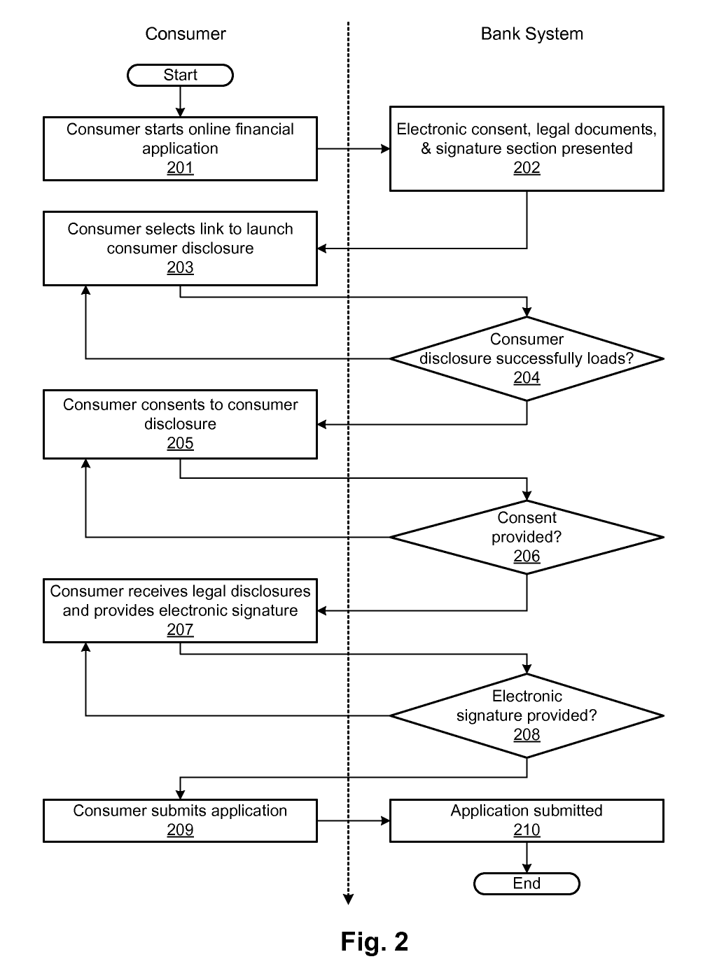

In operation, a consumer using client computer 101 may decide to perform a transaction, such as applying for a new bank account. To do so, the consumer may log in to a web site generated by bank system 103 via the Internet (which would be network 102 in this example). On the web site, the consumer may be presented with an online application form that needs to be filled out. Included with the application form may be the consumer disclosure required by the E-Sign Act. An illustrative overview of this application process, which may be performed by the computing environment of FIG. 1, is shown in FIG. 2. In this example, the consumer is applying for a deposit account at the bank that controls bank system 103. However, the flowchart of FIG. 2 may be easily adapted to be used for any type of transaction that requires electronic disclosure to the consumer.

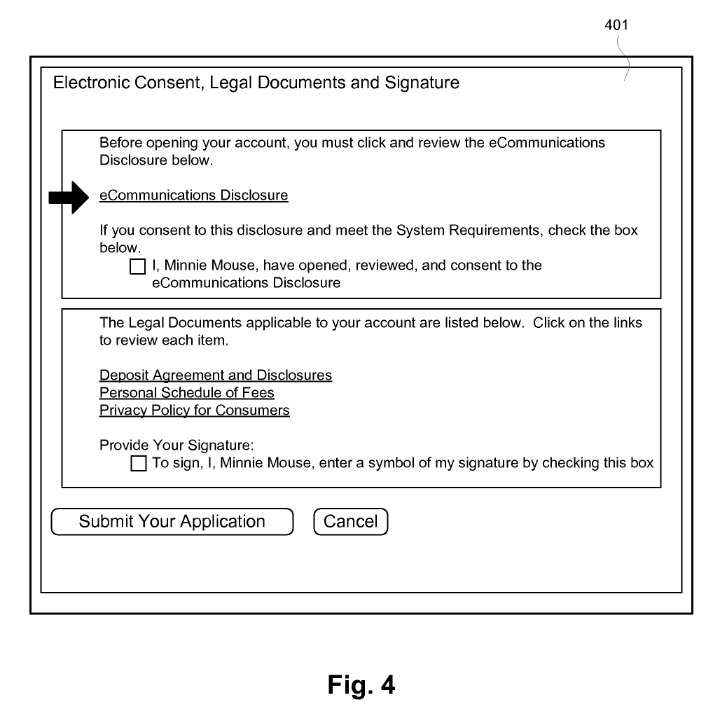

Referring to FIG. 2, the consumer at client computer 101 may begin the online financial application at step 201, such as by visiting an appropriate web site provided by bank system 103 using the web browser running on client computer 101. In step 202, bank system 103 may provide a web page such as an Electronic Consent, Legal Documents, and Signature web page. An example of a screenshot of such a web page as displayed at client computer 101 is shown in FIG. 4. The content of the web page may be displayed in a window, such as window 401. It can also be seen in this example that an arrow is displayed indicating to the consumer what the next step should be in the application process. In this case, the arrow points to an eCommunications Disclosure hyperlink, indicating that it is to be selected by the consumer.

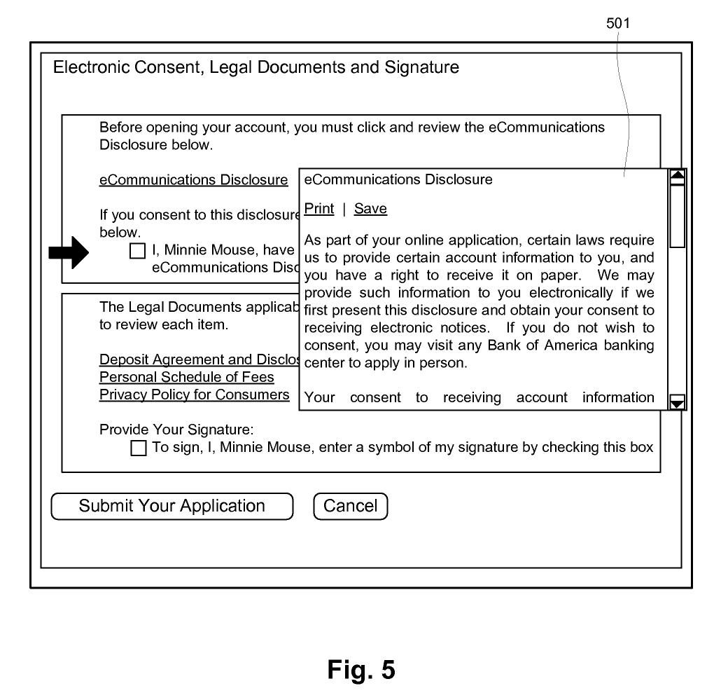

Next, in step 203, the consumer selects a link that launches a secondary window containing the consumer disclosure. For example, referring to FIG. 4, the user-selectable hyperlink (signified by underlined text) entitled “eCommunications Disclosure” is selected by the consumer from client computer 103. In this example, this refers to the consumer disclosure. The secondary window may be, for instance, a pop-up window. Upon selection of this hyperlink, the display at client computer 103 may appear such as shown in FIG. 5. In this example, a pop-up window 501 is displayed containing the content of the consumer disclosure. The consumer may at this point be provided the option to print and/or locally save the consumer disclosure as a file. For instance, this may be performed by selecting a Print and/or Save hyperlink as shown in FIG. 5.

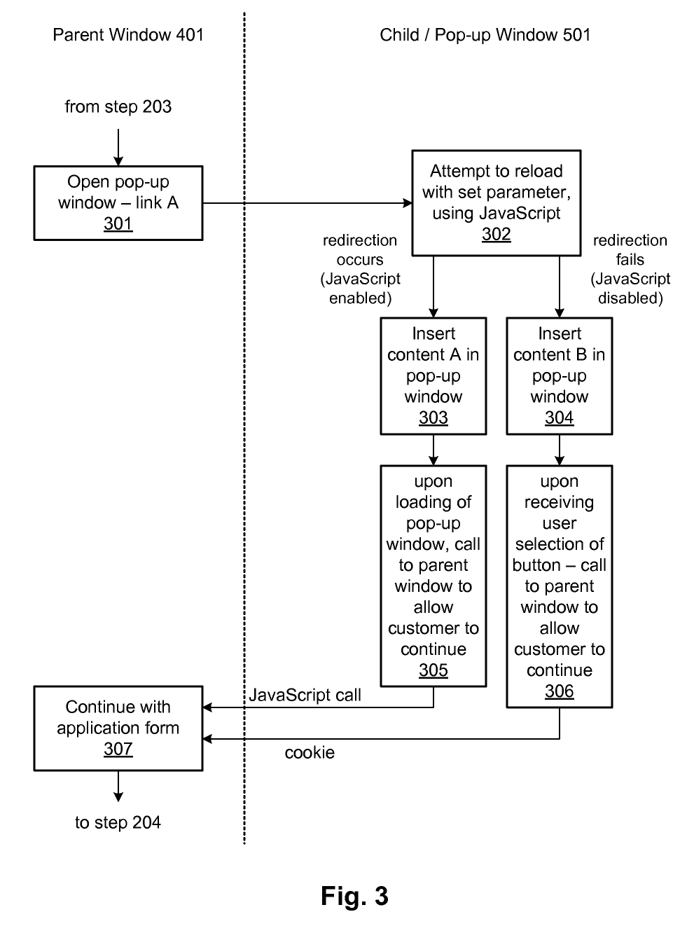

Bank system 103 next determines in step 204 whether the disclosure has successfully loaded onto client computer 103. Details of how this determination may occur are illustratively shown in FIG. 3.

Referring to FIG. 3, when the consumer selects the eCommunications Disclosure hyperlink in step 203 from window 401 (also referred to herein as parent window 401), then in step 301 pop-up window 501 (also referred to as a child window 501 since it emanates from parent window 401) is opened. As will be described below, to determine whether child pop-up window 501 has completed loading, it may be desirable that pop-up window 501 send a JAVASCRIPT call to window 401 upon completion of loading of the content of pop-up window 501. However, client computer 103 may or may not be configured such that its web browser is JAVASCRIPT enabled. Therefore, it may be desirable to be able to also indicate completion of the loading of pop-up window 501 in situations where client computer 103 is not JAVASCRIPT enabled. There is no known direct way of determining whether client computer 103 is JAVASCRIPT enabled. Accordingly, the following steps may be performed to indirectly determine whether JAVASCRIPT is enabled.

Within child window 501, before loading any content, bank system 103 attempts to redirect the web browser of client computer 103 using a JAVASCRIPT function to the same universal resource locator (URL) location, except with an extra URL parameter that indicates whether JAVASCRIPT is enabled. This is represented by step 302 in FIG. 3.

For example, the URL to the original pop-up child window 501 may be https://www.bankofamerica.com/deposits/odao/popup/eComm_disclosure_popup.cfm?template=eComm. However, on entering the original pop-up URL, a JAVASCRIPT function attempts to redirect the web browser of client computer 103 to https://www.bankofamerica.com/deposits/odao/popup/eComm_disclosure_popup.cfm?te mplate=eComm&jsenabled=true, which is the same pop-up URL but with an extra parameter ‘jsenabled=true’. When JAVASCRIPT is disabled, the redirection does not successfully occur because the JAVASCRIPT redirect function will not work. Thus, when JAVASCRIPT is disabled, there will not be a parameter of ‘jsenabled=true’ in the URL. Based on whether the parameter ‘jsenabled=true’ is present or not in the URL, it can be determined whether JAVASCRIPT is enabled in the web browser of client computer 103.

Next in FIG. 3, depending upon whether the redirection has successfully occurred, either steps 303 and 305, or steps 304 and 306, will be performed. If redirection is successful, then in step 303 a particular content (referred to herein as “content A”) is included in pop-up window 501. If redirection is not successful, then in step 304 a different particular content (referred to herein as “content B”) is included in pop-up window 501. Content A may be, for example, a set of text and/or other displayed visible elements such as shown in pop-up window 501 of FIG. 5, along with various HTML code defining pop-up window 501. In addition, for content A, the HTML code may include a load confirmation instruction of a scripting language, such as a JAVASCRIPT ONLOAD command that returns a predetermined value upon completion of loading of content A. Upon the ONLOAD command indicating that loading of content A has completed, a JAVASCRIPT command (also part of content A) may cause a call to be made in step 305 from child pop-up window 501 to parent window 401. In response to the call, in step 307 parent window 401 may be programmed so as to allow the consumer to continue with the application process. In other words, parent window 401 may be programmed so as to prevent the consumer from performing one or more actions until the call is received, as will be described in further detail below. Therefore, the consumer disclosure is effectively non-bypassable. In addition, parent window 401 may be programmed so as to modify at least a portion of its content to indicate a change in status-that is-that the application process may now continue. For example, the arrow shown in FIG. 4 may move down to the next portion of the application form, such as by pointing to the set of hyperlinks (e.g., “Deposit Agreement and Disclosures”) or by pointing to the next check box on the application form.

Content B may be, for example, the same set of text and other displayed elements as in Content A, except the JAVASCRIPT commands (including the ONLOAD command) may be missing. Instead, a displayed user-selectable button or other element may be provided that allows the user to close pop-up window 501. Thus, when JAVASCRIPT is disabled, the pop-up window 501 displays a user-selectable button or other visible element at the bottom. The consumer is allowed to continue with the application process in main window 401 only when the button or other visible element is clicked or otherwise selected to indicate that the customer has read the consumer disclosure. The selection of the button is captured in a cookie, and computer-executable instructions (which may be associated with the parent window) may be provided for determining whether that cookie exists. If the cookie exists, then it is known that the customer selected the button and that the customer received the full consumer disclosure in pop-up window 501. But if the cookie does not exist, then it is known that the customer did not select the button and therefore may not have received the full consumer disclosure in pop-up window 501. In that case, an error message may be presented and the customer may be required to repeat the consumer disclosure process. Therefore, the consumer disclosure is also non-bypassable even where JAVASCRIPT is disabled.

Next, in step 205 of FIG. 2, the consumer consents to the consumer disclosure, such as by checking the uppermost check box shown in FIG. 4 (which in this example confirms that “I, Minnie Mouse, have opened, reviewed, and consent to the eCommunications Disclosure” (where Minnie Mouse is the name of the consumer). In step 206, bank system 103 confirms that this consent has indeed been provided. In addition, a time and/or date stamp of when the consent was provided may be captured by bank system 103 and retained for posterity in the event proof of consent is later needed.

Next, in step 207, the consumer has the option of reviewing various legal disclosures. This may be accomplished, for example, by selecting various hyperlinks or other displayed elements to cause the legal disclosures to appear (such as in pop-up windows). These disclosures may be presented in the same manner, and using the same techniques, as the consumer disclosures to follow, although these additional legal disclosures may be by-passable if desired. For instance, referring to FIG. 4, these legal disclosures may include a Deposit Agreement and Disclosures, a Personal Schedule of Fees, and a Privacy Policy for Consumers. The consumer may also be provided the option to print and/or save these legal disclosures in a similar manner as previously described for the consumer disclosure.

Still referring to step 207, the consumer may further provide his or her electronic signature before or after reviewing the legal disclosures. This may be done by allowing the consumer to enter one or more symbols representing the electronic signature. For example, the electronic signature may be embodied as a check mark in a check box, such as indicated by the lower-most check box in FIG. 4. In step 208, bank system 103 confirms that the electronic signature has been provided by the consumer.

Next, in step 209, the consumer submits the completed application form. This may be accomplished, for example, by the consumer selecting a displayed element such as a Submit button (as in FIG. 4). The application may not be submitted successfully if the non-by passable disclosure functions described above, consent and signature are not executed/provided. Alternatively, the consumer may cancel the transaction by selecting a Cancel button (also as in FIG. 4). In step 210, bank system 103 confirms whether the application form has been submitted or canceled.

Thus, various software, processes, and apparatuses have been described that may be used to enforce the displaying of the consumer disclosure during the application process to be non-bypassable and to confirm that the disclosure has been successfully loaded by the consumer's computer. As previously mentioned, this technique satisfies both the “reasonable demonstration” test required by the E-Sign Act and can be used to ensure that any “non-bypassability” requirements have been met.

Although various features of the invention have been described with reference to a deposit application process through a bank website, many if not all of the features may be equally applicable to other environments. For instance, any web page or local software application may benefit from the features described herein, where the provision of certain information to a user is desired to be non-bypassable during a transaction, or to provide reasonable demonstration that the information has been loaded on the user's computer and presented in the intended format, or where a load execution outside of the parent window must be verified. Moreover, the information to be provided using these techniques is not limited to a consumer disclosure, but may be any information desired.

What is claimed is:

1. A computer-implemented method, comprising:
transmitting first information representing a first window, including a user-selectable visible element, to a client computer;
receiving an indication of a selection of the visible element; and
responsive to the selection, transmitting to the client computer second information representing a second window having content, the second information including computer-executable instructions for determining when the content has been received at the client computer.

2. The computer-implemented method of claim 1, wherein the first information comprises hypertext markup language (HTML) code representing the first window, and the second information comprises HTML code representing the second window.

3. The computer-implemented method of claim 1, wherein the computer-executable instructions includes a load confirmation instruction of a scripting language.

4. The computer-implemented method of claim 1, wherein the second window is a pop-up window.

5. The computer-implemented method of claim 1, wherein the computer-executable instructions are further for sending a call to the first window.

6. The computer-implemented method of claim 5, wherein the first information includes computer-executable instructions for modifying what is displayed in the first window responsive to receiving the call from the second window.

7. A computer-readable medium storing first computer-executable instructions for performing a method, the method comprising:
transmitting first information representing a first window, including a user-selectable visible element, to a client computer;
receiving an indication of a selection of the visible element; and
responsive to the selection, transmitting to the client computer second information representing a second window having content, the second information including second computer-executable instructions for determining when the content has been received at the client computer.

8. The computer-readable medium of claim 7, wherein the second computer-executable instructions are further for sending a call to the first window.

9. The computer-readable medium of claim 8, wherein the first information includes third computer-executable instructions for modifying what is displayed in the first window responsive to receiving the call from the second window.

10. A computer-readable medium storing computer-executable instructions for performing a method, the method comprising:
responsive to receiving a request from a client computer to open a universal resource locator (URL), redirecting the request to the URL including a parameter indicating that JAVASCRIPT is enabled;
responsive to the redirection failing, sending first content to the client computer;
responsive to the redirection occurring, sending second content different from the first content to the client computer.

11. The computer-readable medium of claim 10, wherein the second content includes a JAVASCRIPT command and the first content does not include a JAVASCRIPT command.

12. The computer-readable medium of claim 10, wherein the second content includes a JAVASCRIPT ONLOAD command.

13. The computer-readable medium of claim 10, wherein the first content defines a user-selectable visible element that is not included in the second content.

14. The computer-readable medium of claim 13, wherein the first content further includes computer-executable instructions for setting a cookie responsive to user selection of the visible element.

15. The computer-readable medium of claim 10, wherein the method further comprises sending third content including computer-executable instructions for displaying an element responsive to receiving a call from a window containing the first content or the second content.

16. A computer-implemented method, comprising:
responsive to receiving a request from a client computer to open a universal resource locator (URL), redirecting the request to the URL including a parameter indicating that JAVASCRIPT is enabled;
responsive to the redirection failing, sending first content to the client computer;
responsive to the redirection occurring, sending second content different from the first content to the client computer.

17. The computer-implemented method of claim 16, wherein the second content includes JAVASCRIPT code and the first content does not include JAVASCRIPT code.

18. The computer-implemented method of claim 16, wherein the second content includes a JAVASCRIPT ONLOAD command.

19. The computer-implemented method of claim 16, wherein the first content defines a user-selectable visible element that is not included in the second content.

20. The computer-implemented method of claim 16, wherein the first content further includes computer-executable instructions for setting a cookie responsive to user selection of the visible element.

21. A computer-implemented method, comprising:
displaying in a first window first web page content including a user-selectable first visible element;
responsive to user selection of the first visible element, displaying second web page content in a second window; and
the second window sending a call to the first window responsive to the second web page content being fully loaded.

22. The computer-implemented method of claim 21, further comprising modifying what is displayed in the first window responsive to the first window receiving the call.

23. The computer-implemented method of claim 21, wherein the first web page content further includes a user-selectable second visible element, the method further comprising:
responsive to user selection of the second visible element, displaying either third web page content or fourth web page content depending upon whether the first window has received the call.
